(19) United States
(12) Patent Application Publication
(10) Pub. No.: US 2025/0162216 A1
(43) Pub. Date: May 22, 2025

(54) INJECTION MOLDING MACHINE AND MOLTEN RESIN SUPPLY SYSTEM

(71) Applicant: SUMITOMO HEAVY INDUSTRIES, LTD., Tokyo (JP)

(72) Inventors: Hironobu ISHIDA, Yokosuka-shi (JP); Tsutomu MIYATAKE, Chiba-shi (JP)

(21) Appl. No.: 18/926,440

(22) Filed: Oct. 25, 2024

(30) Foreign Application Priority Data
Nov. 21, 2023 (JP) 2023-197485

(51) Int. Cl. B29C 45/07; B29C 45/17; B29C 45/18

(52) U.S. Cl. CPC B29C 45/07; B29C 45/1761; B29C 45/18

(57) ABSTRACT

An injection molding machine includes an injection unit that injects an input molten resin into a mold, a mold clamping unit that supports the mold to perform mold clamping of the mold, a stand installed on a floor surface to support the injection unit and the mold clamping unit, and a plurality of movement enabling units that enable the stand to move in a protrusion direction of an injection portion of the injection unit, independently of the injection unit and the floor surface.

### CROSS-REFERENCE TO RELATED APPLICATIONS

This application claims priority to Japanese Patent Application No. 2023-197485, filed on Nov. 21, 2023, which is incorporated by reference herein in its entirety.

### BACKGROUND

### Technical Field

Certain embodiments of the present invention relate to an injection molding machine and a molten resin supply system.

### Description of Related Art

In order that a molten resin output from a decontamination machine which

decontaminates contaminants contained inside a recycling target resin by using a mechanical recycling method is directly input to an injection molding machine, the decontamination machine and the injection molding machine may be connected to each other by a pipe. In this case, a connection pipe including a sleeve type expansion/contraction pipe coupling serving as a pipe coupling may be provided to absorb a position movement caused by a purge operation or the like of an injection unit of the injection molding machine (for example, the related art).

### SUMMARY

According to an aspect of the present invention, there is provided an injection molding machine including an injection unit that injects an input molten resin into a mold, a mold clamping unit that supports the mold to perform mold clamping of the mold, a stand installed on a floor surface to support the injection unit and the mold clamping unit, and a plurality of movement enabling units that enable the stand to move in a protrusion direction of an injection portion of the injection unit, independently of the injection unit and the floor surface.

Here, when the stand that supports the mold clamping unit moves in the protrusion direction, independently of the injection unit and the floor surface, the injection unit and the mold may be separated from each other or brought close to each other.

In addition, the stand may be movable in the protrusion direction, independently of the injection unit, via a first movement enabling unit in a plurality of movement enabling units, and may be movable in the protrusion direction, independently of the floor surface via a second movement enabling unit in the plurality of movement enabling units.

In addition, the injection molding machine may further include one or more drive units that move the stand in the protrusion direction.

In addition, the injection molding machine may further include a synchronization mechanism that synchronizes an operation in which the injection unit moves in the protrusion direction, independently of the stand, and an operation in which the stand moves in the protrusion direction, independently of the floor surface.

In addition, the injection molding machine may further include a first locking member that locks a movement of the stand in the protrusion direction.

In addition, the injection molding machine may further include a second locking member that locks a movement of the injection unit in the protrusion direction.

In addition, according to another aspect of the present invention, there is provided an injection molding machine including an injection unit that injects an input molten resin into a mold, a mold clamping unit that supports the mold to perform mold clamping of the mold, a stand that supports the injection unit and the mold clamping unit, and a movement enabling unit that enables the mold clamping unit to move in a protrusion direction of an injection portion of the injection unit, independently of the injection unit and the stand.

Here, when the mold clamping unit moves in the protrusion direction, independently of the injection unit and the stand, the injection unit and the mold may be separated from each other or brought close to each other.

In addition, the injection molding machine may further include a drive unit that moves the mold clamping unit in the protrusion direction.

In addition, the injection molding machine may further include a locking member that locks a movement of the mold clamping unit in the protrusion direction.

In addition, according to still another aspect of the present invention, there is

provided a molten resin supply system including an output unit including an output port for outputting a molten resin, and in which a position of the output port is fixed, and an injection molding machine that molds a molding product by using the output molten resin. The injection molding machine includes an injection unit including an input port of which a position with respect to the output port is fixed, and injecting the molten resin input to the input port into a mold, a mold clamping unit that supports the mold to perform mold clamping of the mold, a stand installed on a floor surface to support the injection unit and the mold clamping unit, and a plurality of movement enabling units that enable the stand to move in a protrusion direction of an injection portion of the injection unit, independently of the injection unit and the floor surface.

In addition, according to still another aspect of the present invention, there is provided a molten resin supply system including an output unit including an output port for outputting a molten resin, and in which a position of the output port is fixed, and an injection molding machine that molds a molding product by using the output molten resin. The injection molding machine includes an injection unit including an input port of which a position with respect to the output port is fixed, and injecting the molten resin input to the input port into a mold, a mold clamping unit that supports the mold to perform mold clamping of the mold, a stand that supports the injection unit and the mold clamping unit, and a movement enabling unit that enables the mold clamping unit to move in a protrusion direction of an injection portion of the injection unit, independently of the injection unit and the stand.

### BRIEF DESCRIPTION OF THE DRAWINGS

FIG. 1 is a view illustrating an example of an overall configuration of a molten resin supply system according to one embodiment.

FIG. 2 is a view illustrating an example of a configuration when a synchronization mechanism is provided in an injection molding machine.

FIG. 3 is a view illustrating an example of a configuration of a linear guide which is a specific example of a movement enabling unit forming the injection molding machine.

FIG. 4 is a view illustrating an outline of a purge operation performed by an injection unit in the related art.

FIG. 5 is a view illustrating a specific example of a coupling of a connection pipe which deforms in accordance with the purge operation of the injection unit in the related art.

FIG. 6 is a view illustrating an example of an overall configuration of a molten resin supply system according to another embodiment.

### DETAILED DESCRIPTION

When the connection pipe including the sleeve type expansion/contraction pipe coupling is provided, a sleeve slides in accordance with the position movement of the injection unit, and the sleeve reciprocates inside and outside the pipe. Therefore, the molten resin passing through the inside of the pipe may be exposed to the outside of the pipe while the molten resin adheres to a surface of the sleeve. In this case, when the sleeve slides, the exposed molten resin may be rubbed and carbonized, thereby creating a possibility that the carbonized resin is mixed into the molten resin as solid foreign matter. In addition, as a coupling other than the sleeve type expansion/contraction pipe coupling, there is a swivel joint, a flexible hose, or the like. These couplings are also deformable in accordance with the position movement of a plasticizing cylinder. However, for structural reasons, the molten resin passing through the inside of the pipe may stagnate. Furthermore, these couplings need to have heat resistance, pressure resistance, and the like to allow the molten resin to pass through the couplings. However, those which satisfy all of these properties are limited. For this reason, it is desirable to realize a method for directly connecting a device that outputs the molten resin and the injection molding machine to each other without disposing the connection pipe including the coupling deforming to absorb the position movement of the injection unit.

It is desirable to directly connect a device that outputs a molten resin and an injection molding machine to each other without disposing a connection pipe including a coupling deforming to absorb a partial position movement of the injection molding machine.

Hereinafter, embodiments of the present invention will be described in detail with reference to the accompanying drawings.

### One Embodiment

### Configuration of Molten Resin Supply System 1

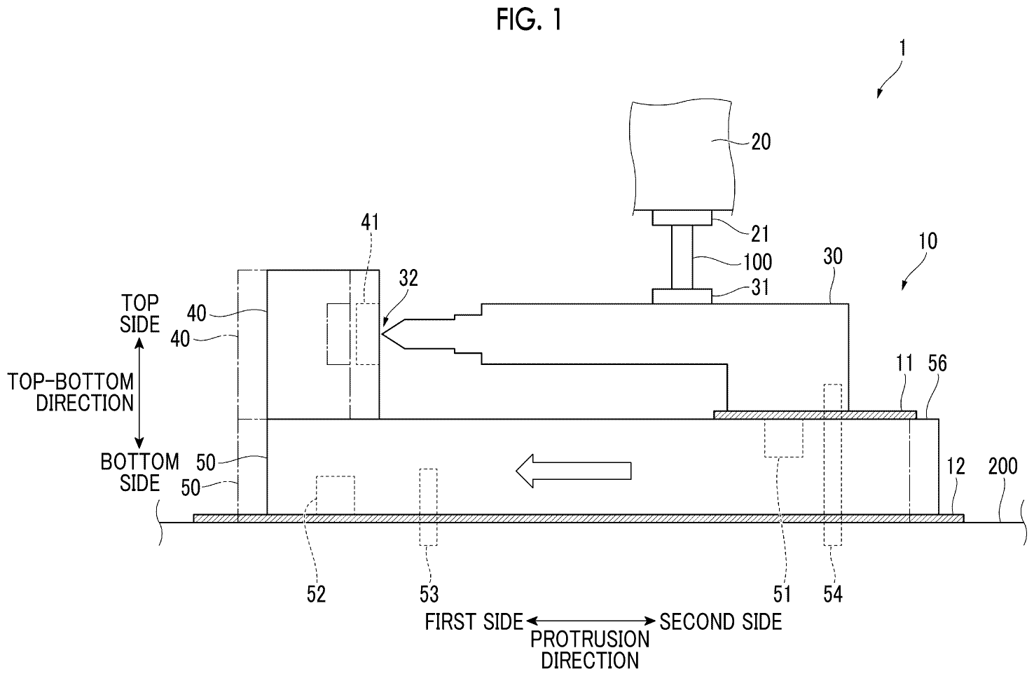

FIG. 1 is a view illustrating an example of an overall configuration of a molten resin supply system 1 according to one embodiment.

The molten resin supply system 1 illustrated in FIG. 1 is a system including an injection molding machine 10 that performs injection molding by using a molten resin, and an output unit 20 that outputs the molten resin to the injection molding machine 10.

### Injection Molding Machine 10

The injection molding machine 10 is a molding machine used for manufacturing a molding product for which a molten resin is used as a material. The injection molding machine 10 is connected to the output unit 20 by a connection pipe 100. The connection pipe 100 is a highly rigid and linear metal pipe, and has heat resistance and pressure resistance for allowing the molten resin to pass through. In addition, the connection pipe 100 has a smooth inner surface, and has a non-stagnating structure in which the molten resin is unlikely to be accumulated.

The injection molding machine 10 includes an injection unit 30, a mold clamping unit 40, and a stand 50. The injection unit 30 includes an input port 31 for inputting the molten resin, and an injection portion 32 for injecting the molten resin input to the input port 31. The input port 31 is provided on a top side of the injection molding machine 10 in a top-bottom direction, and is connected to a bottom side of the connection pipe 100 in the top-bottom direction. When the molten resin output from the output unit 20 is input to the input port 31 via the connection pipe 100, the injection unit 30 performs heating, kneading, and metering on the input molten resin, and injects the molten resin from the injection portion 32 into the mold 41. The injection unit 30 is supported by the stand 50 via a sliding member 11 serving as a first movement enabling unit. For example, the sliding member 11 includes one or more linear guides. A specific configuration of the sliding member 11 will be described later.

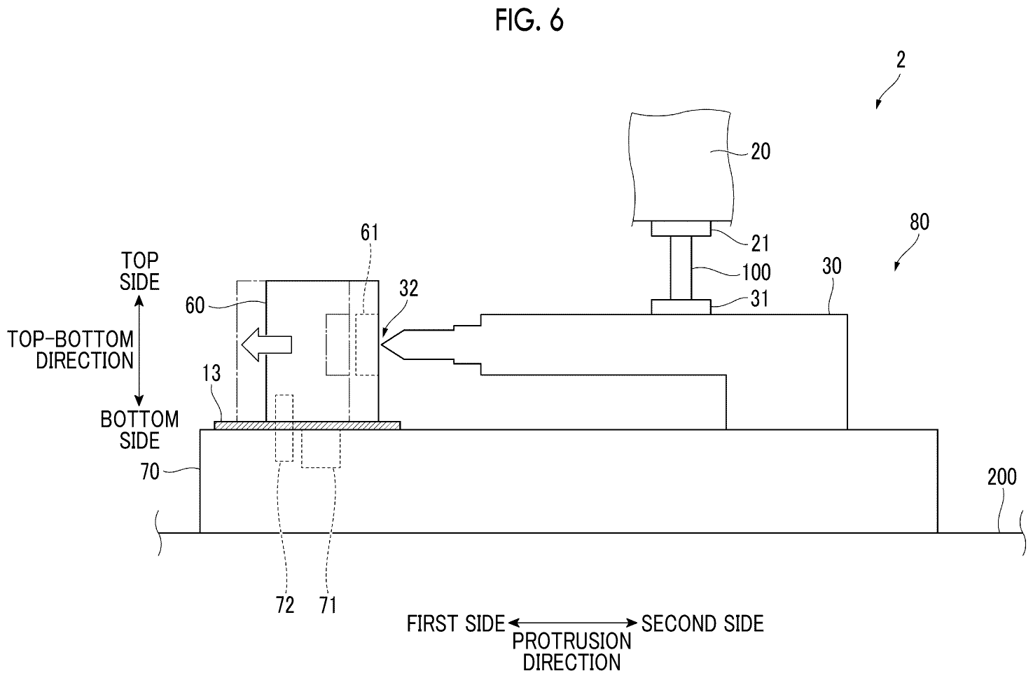

Hereinafter, in the embodiment of the present invention, as a first aspect of a movement enabling unit, a sliding member that enables the stand 50 (refer to FIG. 1) according to one embodiment, a mold clamping unit 60 (refer to FIG. 6) according to another embodiment (to be described later), and the like to slide will be described as an example. That is, the movement enabling unit may be any unit that enables the stand 50 or the like to move. Therefore, the movement enabling unit may be one that enables the stand 50 or the like to move by enabling the stand 50 or the like to slide as in the embodiment of the present invention. For example, the movement enabling unit may enable the stand 50 or the like to move by using a combination of gears and the like.

The mold clamping unit 40 is a device that supports the mold 41 to perform mold clamping of the mold 41 into which the molten resin is injected. The mold 41 is a mold that is opened and closed in a left-right direction in FIG. 1 (that is, a horizontal direction and a direction in which the injection portion 32 of the injection unit 30 protrudes toward the mold 41). Hereinafter, the left-right direction in FIG. 1 will be referred to as a “protrusion direction”, a left side in FIG. 1 will be referred to as a “first side”, and a right side will be referred to as a “second side”. The mold clamping unit 40 is supported by the stand 50 disposed on the bottom side in the top-bottom direction. In one embodiment, the mold clamping unit 40 and the stand 50 are fixed.

The stand 50 is a member that supports the injection unit 30 and the mold clamping unit 40 from the bottom side in the top-bottom direction. Specifically, the stand 50 is fixed to the mold clamping unit 40 in a state of supporting the injection unit 30 via the sliding member 11 from the bottom side in the top-bottom direction, and supporting the mold clamping unit 40 from the bottom side of the mold clamping unit 40 in the top-bottom direction. The stand 50 is installed on a floor surface 200 via a sliding member 12 serving as a second movement enabling unit. For example, the sliding member 12 includes one or more linear guides. A specific configuration of the sliding member 12 will be described later.

### Output Unit 20

The output unit 20 is a device that outputs the molten resin. For example, the output unit 20 uses a method of mechanical recycling (physical regeneration method) or chemical recycling (chemical regeneration method), and decontaminates contaminants contained inside the resin of a PET bottle or the like serving as a recycling target. In this manner, the output unit 20 outputs the resin as the molten resin. The output unit 20 includes an output port 21 for outputting the molten resin. The output port 21 is connected to the top side of the connection pipe 100 in the top-bottom direction, and a position thereof is fixed. The molten resin output from the output port 21 is input to the injection molding machine 10 via the connection pipe 100.

The “mechanical recycling” refers to a series of processes of removing surface dirt or foreign matter by sorting, crushing, and washing resins of used and collected PET bottles or the like, and thereafter diffusing and decontaminating contaminants accumulated inside the resins melted by being exposed to a high temperature, for example, in a vacuum inside the output unit 20. In addition, the “chemical recycling” refers to a series of processes of decontaminating the contaminants by sorting, chemically decomposing, and re-polymerizing the resins of the used and collected PET bottles or the like.

### Purge Operation

Carbide is accumulated inside the injection unit 30 of the injection molding machine 10. The carbide accumulation is a phenomenon in which the molten resin input to the injection unit 30 stagnates, and is burned, carbonized, and accumulated in an internal screw. The carbide accumulation is a factor that causes a molding defect since the carbide accumulated in the screw is peeled and falls off. Therefore, an operation of eliminating the carbide accumulation by squeezing the molten resin from the injection portion 32 of the injection unit 30 and discharging the molten resin to the outside (hereinafter, referred to as a “purge operation”) is periodically performed.

The purge operation includes an operation of separating the injection unit 30 and the mold 41 from each other in the protrusion direction, and an operation of discharging the molten resin to the outside by squeezing the molten resin from the injection portion 32 of the injection unit 30. Specifically, as illustrated in FIG. 1, in a state where the position of the injection unit 30 in the protrusion direction is fixed, the positions of the mold clamping unit 40 and the stand 50 in the protrusion direction are slid to the first side from a position during an operation indicated by a solid line to a position during the purge operation indicated by a one-dot chain line. In one embodiment, the mold clamping unit 40 is fixed to the stand 50. Therefore, when the stand 50 slides to the first side in the protrusion direction, the mold clamping unit 40 also moves to the first side in the protrusion direction. In this manner, a space is formed between the injection unit 30 and the mold 41. Therefore, the molten resin is squeezed from the injection portion 32 of the injection unit 30, and is discharged to the outside by using the space.

The sliding member 11 is a member that enables sliding between the injection unit 30 and the stand 50. In addition, the sliding member 12 is a member that enables sliding between the stand 50 and the floor surface 200. In addition, the injection unit 30 is connected to the output port 21 of the output unit 20 via the highly rigid connection pipe 100, and the position of the output port 21 is fixed. Therefore, in the injection molding machine 10, the stand 50 is slidable without causing the injection unit 30 to slide. That is, the stand 50 is slidable in the protrusion direction, independently of the injection unit 30 and the floor surface 200.

In addition, in some cases, the stand 50 may be unstable in the protrusion direction since the stand 50 is slidable in the protrusion direction, independently of the injection unit 30 and the floor surface 200. That is, when an unintended force is applied to the stand 50, the stand 50 may move in the protrusion direction in some cases. In this case, a locking member 53 serving as a first locking member that locks the sliding of the stand 50 in the protrusion direction may be provided. The locking member 53 is not particularly limited as long as the locking member 53 can lock the sliding of the stand 50 in the protrusion direction, and, for example, may be a latch mechanism that fixes a positional relationship between the stand 50 and the floor surface 200.

In addition, the injection unit 30 is supported by the sliding member 11 to be slidable with respect to the stand 50 as described above. However, in some cases, the injection unit 30 may be unstable in the protrusion direction, such as when the injection unit 30 slides in conjunction with the sliding of the stand 50 depending on an aspect of the connection pipe 100 (for example, low rigidity). In this case, a locking member 54 serving as a second locking member that locks the sliding of the injection unit 30 in conjunction with the sliding of the stand 50 may be provided.

The locking member 54 is not particularly limited as long as the locking member 54 can lock the sliding of the injection unit 30 in the protrusion direction, and, for example, a positional relationship between the injection unit 30 and the floor surface 200 may be fixed by a highly rigid metal structure. In addition, the connection pipe 100 whose position is fixed by being connected to the output port 21 of the output unit 20 and to the input port 31 of the injection unit 30 can also function as the second locking member.

As the purge operation, when the stand 50 is slid in the protrusion direction, the stand 50 may be manually slid by a worker, or a drive unit that drives the sliding member 11 or the sliding member 12 may be provided. For example, the drive unit includes a motor or the like. When the drive unit is provided to cause the stand 50 to slide in the protrusion direction, for example, as illustrated in FIG. 1, a drive unit 51 that operates the sliding member 11 may be provided as a first drive unit, and a drive unit 52 that operates the sliding member 12 may be provided as a second drive unit. The number of the drive units is not particularly limited, and, for example, only the drive unit 51 may be provided, or only the drive unit 52 may be provided. In addition, both the drive unit 51 and the drive unit 52 may be provided, or three or more drive units (not illustrated) may be provided.

### Modification Example

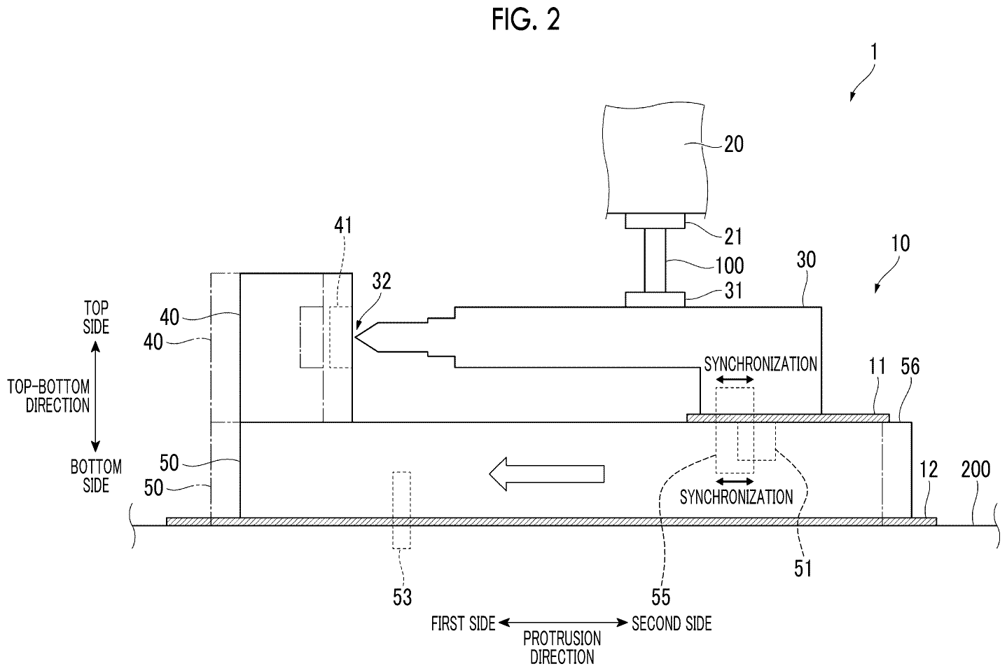

FIG. 2 is a view illustrating an example of a configuration when a synchronization mechanism 55 is provided in the injection molding machine 10.

As described above, when the injection unit 30 is unstable in the protrusion direction, such as when the injection unit 30 slides in conjunction with the sliding of the stand 50, in some cases, the locking member 54 (refer to FIG. 1) serving as the second locking member that locks the sliding of the injection unit 30 in conjunction with the sliding of the stand 50 may be provided. In this manner, even when the stand 50 slides in the protrusion direction, the sliding of the injection unit 30 in conjunction with the sliding of the stand 50 is locked. In addition, since the synchronization mechanism 55 is provided in the injection molding machine 10, the injection unit 30 cannot slide in conjunction with the sliding of the stand 50.

The synchronization mechanism 55 is a mechanism that moves in conjunction with driving of the drive unit 51 that operates the sliding member 11, and synchronizes an operation in which the injection unit 30 slides in the protrusion direction, independently of the stand 50, and an operation in which the stand 50 slides in the protrusion direction, independently of the floor surface 200. Specifically, for example, the synchronization mechanism 55 synchronizes the operations by using one or more belts or chains and by associating the operation in which the injection unit 30 slides in the protrusion direction with the operation in which the stand 50 slides in the protrusion direction.

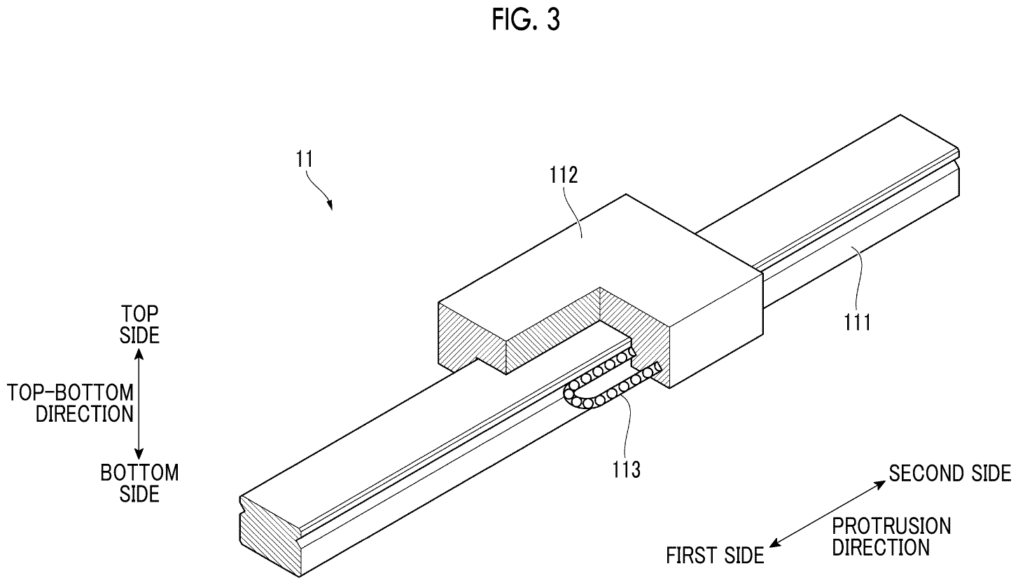

FIG. 3 is a view illustrating an example of a configuration of a linear guide which is a specific example of the sliding member 11 forming the injection molding machine 10.

The linear guide which is a specific example of the sliding member 11 includes a rail portion 111 having a linear shape, a block portion 112 that slides along the rail portion 111, and a bearing portion 113 that enables smooth sliding of the block portion 112. When the linear guide illustrated in FIG. 3 is disposed as the sliding member 11 between the injection unit 30 and the stand 50 in FIG. 1, one or more linear guides are installed at a position where the injection unit 30 slides on a top side surface 56 of the stand 50 in the top-bottom direction. Specifically, the linear guide is installed such that a direction of the rail portion 111 is parallel to the protrusion direction, and the injection unit 30 is installed such that the block portion 112 supports the injection unit 30 from the bottom side in the top-bottom direction.

In this case, a length of the rail portion 111 in the protrusion direction is determined in view of a size of the injection unit 30, a sliding length of the stand 50 in the protrusion direction, and the like. In addition, the length of the block portion 112 in the protrusion direction and the number of the block portions 112 to be disposed are not particularly limited as long as the block portion 112 sliding along the rail portion 111 can stably support the injection unit 30. For example, the length of the block portion 112 in the protrusion direction and the number of the block portions 112 to be disposed are determined depending on the size or the like of the injection unit 30.

In addition, the linear guide described as a specific example of the sliding member 11 in FIG. 3 can also be a specific example of the sliding member 12 in FIG. 1. In this case, the linear guide illustrated in FIG. 3 is installed between the stand 50 in FIG. 1 and the floor surface 200 as the sliding member 12. Specifically, one or more linear guides are installed at a position where the stand 50 slides on the floor surface 200 such that a direction of the rail portion 111 is parallel to the protrusion direction. In addition, the stand 50 is installed such that one or more block portions 112 support the stand 50 from the bottom side in the top-bottom direction.

The length of the rail portion 111 in the protrusion direction is determined in view of the length of the stand 50 in the protrusion direction, the sliding length of the stand 50 in the protrusion direction, and the like. In addition, the length of the block portion 112 in the protrusion direction and the number of the block portions 112 disposed in the rail portion 111 are not particularly limited as long as the block portion 112 sliding along the rail portion 111 can stably support the stand 50. For example, the length of the block portion 112 in the protrusion direction and the number of the block portions 112 disposed in the rail portion 111 are determined depending on the length of the stand 50 in the protrusion direction and the like.

A leg portion such as a leveling pad and an adjuster foot may be installed in the injection molding machine 10 in FIG. 1 to ensure stability and a horizontal posture of the injection molding machine 10. In this case, for example, the length of the linear guide serving as the sliding member 12 in the protrusion direction and the number of the linear guides are determined in accordance with the number of the leg portions to be installed, and the linear guide is installed between each of the leg portions and the floor surface 200.

A configuration of the linear guide illustrated in FIG. 3 is merely an example, and any linear guide existing in the related art can be adopted as the sliding members 11 and 12 in FIG. 1. For example, a structure (for example, one or more screw holes) for joining the injection unit 30 or the stand 50 to the block portion 112 may be provided on a top side surface of the block portion 112 illustrated in FIG. 3 in the top-bottom direction. In addition, the sliding members 11 and 12 in FIG. 1 are not limited to the linear guides, and any member may be adopted as long as the member enables the stand 50 to slide in the protrusion direction with respect to the injection unit 30 and the floor surface 200.

### Purge Operation in Related Art

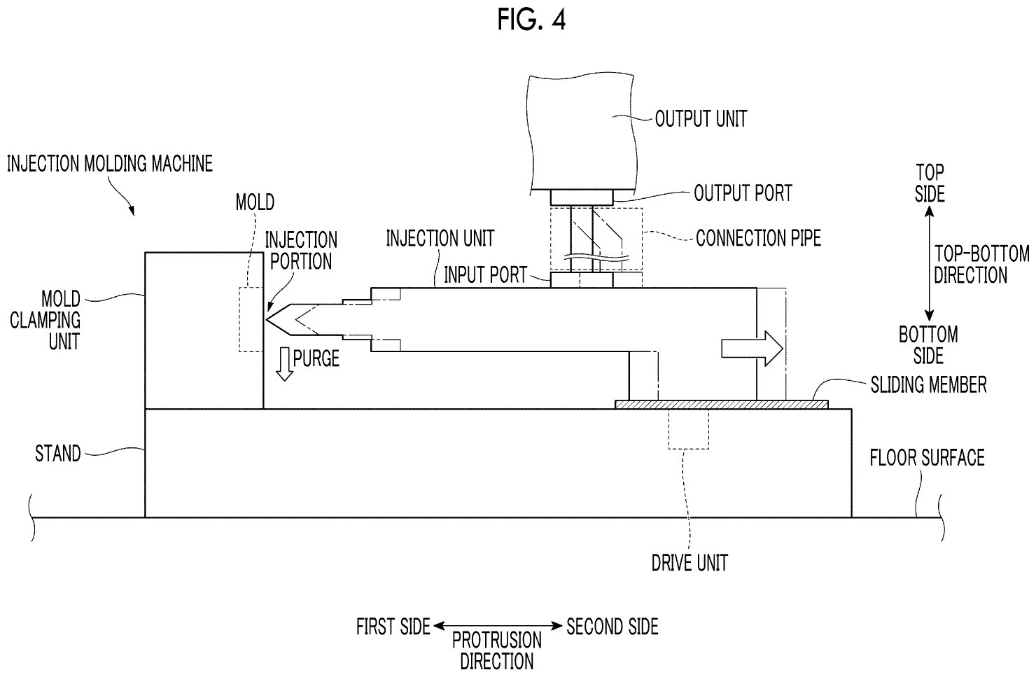

FIG. 4 is a view illustrating an outline of the purge operation performed by the injection unit in the related art.

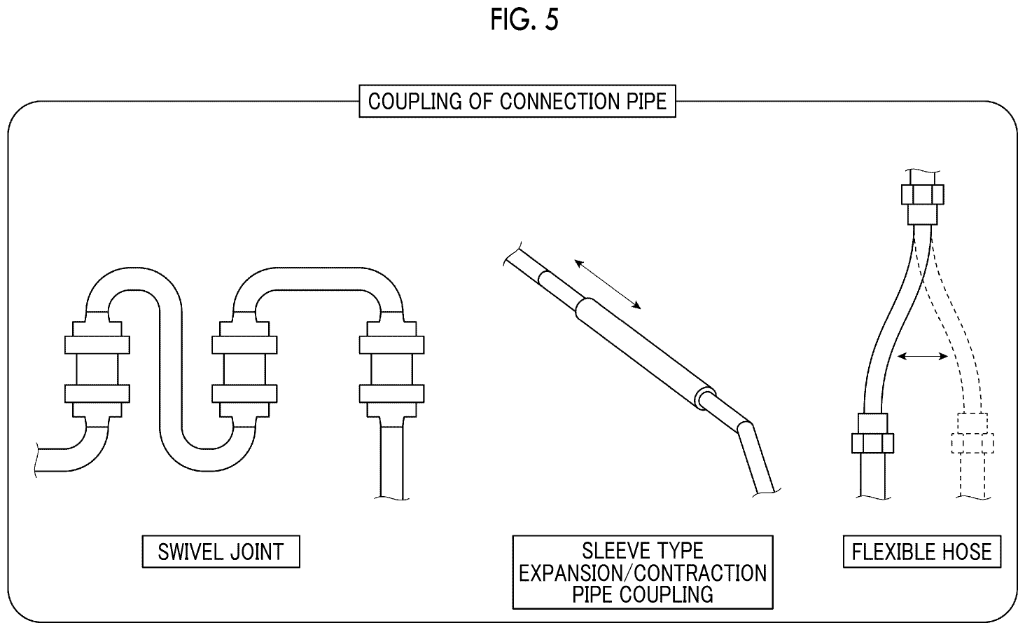

FIG. 5 is a view illustrating a specific example of a coupling of a connection pipe which deforms in accordance with the purge operation of the injection unit in the related art.

FIG. 4 illustrates the output unit including the output port for outputting the molten resin, the injection molding machine that molds a molding product by using the output molten resin, and the connection pipe including a pipe for connecting the output unit and the injection molding machine.

In FIG. 4, the output port of the output unit is fixed such that the position is not moved. The injection molding machine includes the injection unit, the mold clamping unit, and the stand. The injection unit has the input port for inputting the molten resin, and injects the input molten resin from the injection portion into the mold. The mold clamping unit supports the mold, and performs mold clamping on the mold into which the molten resin is injected. The stand supports the injection unit and the mold clamping unit from the bottom side in the top-bottom direction, and is fixed to the floor surface. In addition, in FIG. 4, the protrusion direction is a horizontal direction as in the protrusion direction in FIG. 1 described above, and is a direction in which the injection portion of the injection unit protrudes toward the mold.

The stand in FIG. 4 supports the injection unit via the sliding member from the bottom side in the top-bottom direction. The sliding member is operated by the drive unit. Therefore, the injection unit is slidable in the protrusion direction, independently of the stand fixed to the floor surface. As the periodically performed purge operation, the injection unit slides in the protrusion direction, independently of the stand. The purge operation includes an operation in which the injection unit and the mold are separated from each other in the protrusion direction, and an operation in which the molten resin is squeezed from the injection portion of the injection unit and is discharged to the outside. Specifically, as illustrated in FIG. 4, in a state where the position of each of the mold clamping unit and the stand in the protrusion direction is fixed, the position of the injection unit in the protrusion direction is slid to the second side from a position during an operation indicated by a solid line to a position during the purge operation indicated by a one-dot chain line. In this manner, a space is formed between the injection unit and the mold. Therefore, the molten resin is squeezed from the injection portion of the injection unit, and is discharged to the outside by using the space.

In this case, the connection pipe that connects the output port of the output unit and the input port of the injection unit by using a pipe absorbs a position movement of the injection unit which is caused by the purge operation in such a manner that the pipe is partially deformed in accordance with the purge operation of the injection unit. In this manner, even in a state where the position of the output port of the output unit is fixed, it is possible to cope with the position movement of the input port which is caused by the purge operation of the injection unit.

FIG. 5 illustrates a plurality of swivel joints, a sleeve type expansion/contraction pipe coupling, and a flexible hose, as specific examples of the coupling of the connection pipe which deforms in accordance with the purge operation of the injection unit in the related art. The swivel joint is a coupling that rotatably connects a plurality of pipes. The sleeve type expansion/contraction pipe coupling is a coupling that connects two pipes having the same center axis direction to be expandable/contractible in the center axis direction by causing a sleeve to slide. The flexible hose is a hose-shaped bendable coupling that connects two pipes.

Even when the position of the input port of the injection unit in the protrusion direction is moved by the purge operation of the injection unit, each of the plurality of swivel joints absorbs the movement within a rotatable range of each of the plurality of swivel joints. However, a slight gap is formed inside the swivel joint for structural reasons. Therefore, a portion of the molten resin passing through the swivel joints may enter the gap. In this case, the molten resin may stagnate, and the stagnating molten resin may be solidified, thereby creating a possibility that the solidified resin is mixed into the molten resin as solid foreign matter.

Even when the position of the input port of the injection unit in the protrusion direction is moved by the purge operation of the injection unit, the sleeve type expansion/contraction pipe coupling absorbs the movement within a range of a reciprocating sliding distance of the sleeve. However, in the sleeve type expansion/contraction pipe coupling, the sleeve reciprocates inside and outside the pipe for structural reasons. Therefore, the molten resin exposed to the outside of the pipe may be rubbed and carbonized, thereby creating a possibility that the carbonized resin is mixed into the molten resin as solid foreign matter. In particular, as the reciprocating sliding distance of the sleeve becomes longer and an area of the portion exposed to the outside of the pipe becomes larger, the solid foreign matter is more likely to be formed.

The flexible hose absorbs the movement within a bendable range of the flexible hose, even when the position of the input port of the injection unit in the protrusion direction is moved by the purge operation of the injection unit. However, many gaps having a waveform are formed inside the flexible hose for structural reasons. Therefore, a portion of the molten resin passing through the inside of the flexible hose may enter the gaps. In this case, the molten resin may stagnate, and the stagnating molten resin may be solidified, thereby creating a possibility that the solidified resin is mixed into the molten resin as solid foreign matter.

In this way, the swivel joint, the sleeve type expansion/contraction pipe coupling, and the flexible hose, which are couplings of the connection pipe, are all deformable in accordance with the position movement of the input port of the injection unit in the protrusion direction. However, in any of the above-described couplings, there is an issue for structural reasons in that the molten resin stagnates inside the coupling. Furthermore, these couplings need to have heat resistance, pressure resistance, and the like to allow the molten resin to pass through the couplings. Therefore, it is preferable to adopt a configuration as follows. As in the injection molding machine 10 illustrated in FIG. 1, the output unit 20 is directly connected to the injection molding machine 10 without disposing the connection pipe including the coupling deforming to absorb the position movement of the injection unit 30.

As a summary of the above-described configurations, the injection molding machine 10 according to one embodiment of the present invention can adopt various embodiments as long as the following configurations are adopted.

That is, the injection molding machine 10 includes the injection unit 30 that injects the input molten resin into the mold 41, the mold clamping unit 40 that supports the mold 41 to perform mold clamping of the mold 41, the stand 50 installed on the floor surface 200 to support the injection unit 30 and the mold clamping unit 40, and the plurality of movement enabling units (for example, the sliding members 11 and 12) that enable the stand 50 to move in the protrusion direction of the injection portion 32 of the injection unit 30, independently of the injection unit 30 and the floor surface 200.

In this manner, the stand 50 installed on the floor surface 200 is movable in the protrusion direction of the injection portion 32 of the injection unit 30, independently of the injection unit 30 and the floor surface 200. Therefore, for example, as the purge operation, the injection unit 30 and the mold 41 can be separated from each other or brought close to each other. As a result, the output unit 20 and the injection molding machine 10 can be directly connected to each other without disposing the connection pipe deforming to absorb the position movement of the injection unit 30 which is a portion of the injection molding machine 10.

Here, when the stand 50 that supports the mold clamping unit 40 moves in the protrusion direction, independently of the injection unit 30 and the floor surface 200, the injection unit 30 and the mold 41 may be separated from each other or brought close to each other.

In this manner, the stand 50 installed on the floor surface 200 can be moved in the protrusion direction, independently of the injection unit 30 and the floor surface 200. Therefore, for example, as the purge operation, the injection unit 30 and the mold 41 can be separated from each other or brought close to each other.

In addition, the stand 50 may be movable in the protrusion direction, independently of the injection unit 30, via the sliding member 11 serving as the first movement enabling unit in the plurality of movement enabling units, and may be movable in the protrusion direction, independently of the floor surface 200 via the sliding member 12 serving as the second movement enabling unit in the plurality of movement enabling units.

In this manner, the stand 50 is movable in the protrusion direction, independently of the injection unit 30, via the sliding member 11, and is movable in the protrusion direction, independently of the floor surface 200 via the sliding member 12. Therefore, the stand 50 can be independently moved in the protrusion direction in a state where the position of the injection unit is fixed.

In addition, one or more drive units (for example, the drive units 51 and 52) that move the stand 50 in the protrusion direction may be further provided.

In this manner, one or more drive units move the stand 50 in the protrusion direction. Therefore, for example, the purge operation can be automatically performed.

In addition, the synchronization mechanism 55 that synchronizes an operation in which the injection unit 30 moves in the protrusion direction, independently of the stand 50, and an operation in which the stand 50 moves in the protrusion direction, independently of the floor surface 200, may be further provided.

In this manner, the synchronization mechanism 55 synchronizes an operation in which the stand 50 moves in the protrusion direction, independently of the injection unit 30, and an operation in which the stand 50 moves in the protrusion direction, independently of the floor surface 200. As a result, for example, the movement of the injection unit 30 in conjunction with the movement of the stand 50 can be suppressed without providing the locking member 54 as the second locking member.

In addition, the locking member 53 serving as the first locking member that locks the movement of the stand 50 in the protrusion direction may be further provided.

In this manner, the locking member 53 serving as the first locking member locks the movement of the stand 50 in the protrusion direction. Therefore, it is possible to prevent the stand 50 from becoming unstable in the protrusion direction.

In addition, the locking member 54 as the second locking member that locks the movement of the injection unit 30 in the protrusion direction may be further provided.

In this manner, the locking member 54 serving as the second locking member locks the movement of the injection unit 30 in the protrusion direction. Therefore, it is possible to suppress the movement of the injection unit 30 in conjunction with the movement of the stand 50.

In addition, the molten resin supply system 1 according to one embodiment of the present invention can adopt various embodiments as long as the following configurations are adopted.

That is, the molten resin supply system 1 includes the output unit 20 including the output port 21 for outputting the molten resin and in which the position of the output port 21 is fixed, and the injection molding machine 10 that molds the molding product by using the output molten resin. The injection molding machine 10 includes the injection unit 30 including the input port 31 in which the position with respect to the output port 21 is fixed, and injecting the molten resin input from the input port 31 into the mold 41, the mold clamping unit 40 that supports the mold 41 to perform mold clamping of the mold 41, the stand 50 installed on the floor surface 200 to support the injection unit 30 and the mold clamping unit 40, and the plurality of movement enabling units (for example, the sliding members 11 and 12) that move the stand 50 in the protrusion direction of the injection portion 32 of the injection unit 30, independently of the injection unit 30 and the floor surface 200.

In this manner, the stand 50 installed on the floor surface 200 is movable in the protrusion direction of the injection portion 32 of the injection unit 30, independently of the injection unit 30 and the floor surface 200. Therefore, for example, as the purge operation, the injection unit 30 and the mold 41 can be separated from each other or brought close to each other. As a result, the output unit 20 and the injection molding machine 10 can be directly connected to each other without disposing the connection pipe deforming to absorb the position movement of the injection unit 30 which is a portion of the injection molding machine 10.

### Another Embodiment

### Configuration of Molten Resin Supply System 2

FIG. 6 is a view illustrating an example of an overall configuration of a molten resin supply system 2 according to another embodiment.

The molten resin supply system 2 illustrated in FIG. 6 is a system including an injection molding machine 80 that performs injection molding by using the molten resin, and an output unit 20 that outputs the molten resin to the injection molding machine 80. The output unit 20 is the same as that in one embodiment described above, and description thereof will be omitted.

### Injection Molding Machine 80

The injection molding machine 80 is a molding machine used for manufacturing the molding product by using the molten resin as a material, as in the injection molding machine 10 in FIG. 1 described above, and is connected to the bottom side in the top-bottom direction with respect to the output unit 20. The injection molding machine 80 and the output unit 20 are connected by the connection pipe 100.

The injection molding machine 80 includes the injection unit 30, the mold clamping unit 60, and a stand 70. The injection unit 30 has essentially the same configuration as that of one embodiment. That is, when the molten resin output from the output unit 20 is input to the input port 31 via the connection pipe 100, the injection unit 30 performs heating, kneading, and metering on the input molten resin, and injects the molten resin into a mold 61 (to be described later) from the injection portion 32. However, unlike one embodiment, the injection unit 30 is fixed to the stand 70 that supports the injection unit 30 itself.

The mold clamping unit 60 is a device that supports the mold 61 to perform mold clamping of the mold 61 into which the molten resin is injected. The mold 61 is a mold that is opened and closed in the left-right direction (horizontal direction and a direction in which the injection portion 32 of the injection unit 30 protrudes toward the mold 61) in FIG. 6. Hereinafter, the left-right direction in FIG. 6 will be referred to as the “protrusion direction”. The mold clamping unit 60 is supported to be slidable via a sliding member 13 in the protrusion direction on the stand 70 disposed on the bottom side in the top-bottom direction. That is, one embodiment adopts a configuration in which the mold clamping unit 40 and the stand 50 are fixed to each other. However, another embodiment adopts a configuration in which the mold clamping unit 60 is slidable in the protrusion direction, independently of the stand 70.

The stand 70 is a member that supports the injection unit 30 and the mold clamping unit 60 from the bottom side in the top-bottom direction. Specifically, the stand 70 supports the injection unit 30 in a state of being fixed to the bottom side of the injection unit 30 in the top-bottom direction, and supports the mold clamping unit 60 from the bottom side in the top-bottom direction via the sliding member 13. The sliding member 13 supports the mold clamping unit 60 to be slidable in the protrusion direction, independently of the stand 70. For example, the sliding member 13 includes one or more linear guides, as in the sliding members 11 and 12 in FIG. 1.

### Purge Operation

The injection unit 30 of the injection molding machine 80 periodically performs the purge operation.

The purge operation includes an operation of separating the injection unit 30 and the mold 61 from each other in the protrusion direction, and an operation of squeezing the molten resin from the injection portion 32 of the injection unit 30 to be discharged to the outside. Specifically, as illustrated in FIG. 6, in a state where the position of each of the injection unit 30 and the stand 70 in the protrusion direction is fixed, the position of the mold clamping unit 60 in the protrusion direction is moved to the first side from a position during the operation indicated by a solid line to a position during the purge operation indicated by a one-dot chain line. That is, in another embodiment, unlike one embodiment, the mold clamping unit 60 is not fixed to the stand 70. Therefore, the mold clamping unit 60 is slid to the first side in the protrusion direction in a state where the stand 70 is fixed. In this manner, a space is formed between the injection unit 30 and the mold 61. Therefore, the molten resin is squeezed from the injection portion 32 of the injection unit 30 to be discharged to the outside by using the space.

In some cases, the mold clamping unit 60 may be unstable in the protrusion direction since the mold clamping unit 60 is slidable in the protrusion direction, independently of the injection unit 30 and the stand 70. That is, when an unintended force is applied to the mold clamping unit 60, the mold clamping unit 60 may move in the protrusion direction in some cases. In this case, a locking member 72 that locks the sliding of the mold clamping unit 60 in the protrusion direction may be provided. The locking member 72 is not particularly limited as long as the locking member 72 can lock the sliding of the mold clamping unit 60 in the protrusion direction, and, for example, may be a latch mechanism that fixes a positional relationship between the mold clamping unit 60 and the stand 70.

When the mold clamping unit 60 is slid in the protrusion direction, the mold clamping unit 60 may be manually slid by a worker, or a drive unit 71 that drives the sliding member 13 may be provided. For example, the drive unit 71 includes a motor or the like.

As a summary of the above-described configurations, the injection molding machine 80 according to another embodiment of the present invention can adopt various embodiments as long as the following configurations are adopted.

That is, the injection molding machine 80 includes the injection unit 30 that injects the input molten resin into the mold 61, the mold clamping unit 60 that supports the mold 61 to perform mold clamping of the mold 61, the stand 70 that supports the injection unit 30 and the mold clamping unit 60, and the movement enabling unit (for example, the sliding member 13) that enables the mold clamping unit 60 to move in the protrusion direction of the injection portion 32 of the injection unit 30, independently of the injection unit 30 and the stand 70.

In this manner, the mold clamping unit 60 that supports the mold 61 is movable in the protrusion direction of the injection portion 32 of the injection unit 30, independently of the injection unit 30 and the stand 70. Therefore, for example, as the purge operation, the injection unit 30 and the mold 61 can be separated from each other or brought close to each other. As a result, the output unit 20 and the injection molding machine 80 can be directly connected to each other without disposing the connection pipe deforming to absorb the position movement of the injection unit 30 which is a portion of the injection molding machine 80.

Here, when the mold clamping unit 60 moves in the protrusion direction, independently of the injection unit 30 and the stand 70, the injection unit 30 and the mold 61 may be separated from each other or brought close to each other.

In this manner, the mold clamping unit 60 can be moved in the protrusion direction, independently of the injection unit 30 and the stand 70. Therefore, for example, as the purge operation, the injection unit 30 and the mold 61 can be separated from each other or brought close to each other.

In addition, the drive unit 71 that moves the mold clamping unit 60 in the protrusion direction, independently of the injection unit 30 and the stand 70, may be further provided.

In this manner, the drive unit 71 moves the mold clamping unit 60 in the protrusion direction. Therefore, for example, the purge operation can be automatically performed.

In addition, the locking member 72 that locks the movement of the mold clamping unit 60 in the protrusion direction may be further provided.

In this manner, the locking member 72 locks the movement of the mold clamping unit 60 in the protrusion direction. Therefore, it is possible to prevent the mold clamping unit 60 from becoming unstable in the protrusion direction.

In addition, the molten resin supply system 2 according to another embodiment of the present invention can adopt various embodiments as long as the following configurations are adopted.

That is, the molten resin supply system 2 includes the output unit 20 including the output port 21 for outputting the molten resin and in which the position of the output port 21 is fixed, and the injection molding machine 80 that molds the molding product by using the output molten resin. The injection molding machine 80 includes the injection unit 30 including the input port 31 in which the position with respect to the output port 21 is fixed, and injecting the molten resin input from the input port 31 into the mold 61, the mold clamping unit 60 that supports the mold 61 to perform mold clamping of the mold 61, the stand 70 that supports the injection unit 30 and the mold clamping unit 60, and the sliding member 13 that enables the mold clamping unit 60 to move in the protrusion direction of the injection portion 32 of the injection unit 30, independently of the injection unit 30 and the stand 70.

In this manner, the mold clamping unit 60 that supports the mold 61 is movable in the protrusion direction of the injection portion 32 of the injection unit 30, independently of the injection unit 30 and the stand 70. Therefore, for example, as the purge operation, the injection unit 30 and the mold 61 can be separated from each other or brought close to each other. As a result, the output unit 20 and the injection molding machine 80 can be directly connected to each other without disposing the connection pipe deforming to absorb the position movement of the injection unit 30 which is a portion of the injection molding machine 80.

### Comparison of Embodiments

When the injection molding machine 10 according to one embodiment and the injection molding machine 80 according to another embodiment are compared, in a state where the position of the injection unit 30 is fixed, both of the injection molding machines 10 and 80 are common to each other in that the injection unit 30 and the mold clamping unit can be separated or brought close to each other in the protrusion direction. In this manner, the purge operation can be performed in the injection molding machine. However, in one embodiment, in the purge operation, the stand 50 that supports the mold clamping unit 40 is slid in the protrusion direction. In contrast, in another embodiment, in the purge operation, only the mold clamping unit 60 is slid in the protrusion direction.

With regard to this point, in one embodiment, in order to enable the stand 50 that supports the mold clamping unit 40 to slide in the protrusion direction, independently of the injection unit 30 and the floor surface 200, the sliding member 11 serving as the first movement enabling unit is disposed between the injection unit 30 and the stand 50, and the sliding member 12 serving as the second movement enabling unit is disposed between the stand 50 and the floor surface 200. In contrast, in another embodiment, the movement enabling unit that enables the mold clamping unit 60 to slide in the protrusion direction, independently of the injection unit 30 and the stand 70, is disposed. Specifically, the sliding member 13 is disposed between the mold clamping unit 60 and the stand 70.

Here, in one embodiment, the sliding members 11 and 12 need to be disposed. In contrast, in another embodiment, only the sliding member 13 needs to be disposed. Therefore, the number of components to be used is reduced to achieve a simple configuration. However, for inherent structural reasons of the injection molding machine, operation stability is higher when the mold clamping unit and the stand are fixed to each other. Therefore, when high stability is required during the operation of the injection molding machine, it is preferable to adopt one embodiment using an integral structure by fixing the mold clamping unit 40 to the stand 50, compared to another embodiment in which the mold clamping unit 60 is slidable in the protrusion direction, independently of the stand 70.

It should be understood that the invention is not limited to the above-described embodiment, but may be modified into various forms on the basis of the spirit of the invention. Additionally, the modifications are included in the scope of the invention.

What is claimed is:

1. An injection molding machine comprising:
an injection unit that injects an input molten resin into a mold;
a mold clamping unit that supports the mold to perform mold clamping of the mold;
a stand installed on a floor surface to support the injection unit and the mold clamping unit; and
a plurality of movement enabling units that enable the stand to move in a protrusion direction of an injection portion of the injection unit, independently of the injection unit and the floor surface.

2. The injection molding machine according to claim 1,
wherein when the stand that supports the mold clamping unit moves in the protrusion direction, independently of the injection unit and the floor surface, the injection unit and the mold are separated from each other or brought close to each other.

3. The injection molding machine according to claim 1,
wherein the stand is movable in the protrusion direction, independently of the injection unit, via a first movement enabling unit in the plurality of movement enabling units, and is movable in the protrusion direction, independently of the floor surface, via a second movement enabling unit in the plurality of movement enabling units.

4. The injection molding machine according to claim 3,
wherein the injection unit is supported by the stand via a sliding member serving as the first movement enabling unit.

5. The injection molding machine according to claim 4,
wherein the sliding member includes one or more linear guides.

6. The injection molding machine according to claim 5,
wherein the sliding member is a member that enables sliding between the injection unit and the stand, and is a member that enables sliding between the stand and the floor surface.

7. The injection molding machine according to claim 1, further comprising:
one or more drive units that move the stand in the protrusion direction.

8. The injection molding machine according to claim 7, further comprising:
a synchronization mechanism that synchronizes an operation in which the injection unit moves in the protrusion direction, independently of the stand, and an operation in which the stand moves in the protrusion direction, independently of the floor surface.

9. The injection molding machine according to claim 7,
wherein the drive unit is a motor.

10. The injection molding machine according to claim 1, further comprising:
a first locking member that locks a movement of the stand in the protrusion direction.

11. The injection molding machine according to claim 1, further comprising:
a second locking member that locks a movement of the injection unit in the protrusion direction.

12. The injection molding machine according to claim 1,
wherein the injection unit is connected to an output port of an output unit via a connection pipe, a position of the output port is fixed, and the stand is slidable without causing the injection unit to slide.

13. The injection molding machine according to claim 12,
wherein the stand is slidable in the protrusion direction, independently of the injection unit and the floor surface.

14. An injection molding machine comprising:
an injection unit that injects an input molten resin into a mold;
a mold clamping unit that supports the mold to perform mold clamping of the mold;
a stand that supports the injection unit and the mold clamping unit; and
a movement enabling unit that enables the mold clamping unit to move in a protrusion direction of an injection portion of the injection unit, independently of the injection unit and the stand.

15. The injection molding machine according to claim 14,
wherein when the mold clamping unit moves in the protrusion direction, independently of the injection unit and the stand, the injection unit and the mold are separated from each other or brought close to each other.

16. The injection molding machine according to claim 14, further comprising:
a drive unit that moves the mold clamping unit in the protrusion direction.

17. The injection molding machine according to claim 14, further comprising:
a locking member that locks a movement of the mold clamping unit in the protrusion direction.

18. A molten resin supply system comprising:
an output unit including an output port for outputting a molten resin, and in which a position of the output port is fixed; and
an injection molding machine that molds a molding product by using the output molten resin,
wherein the injection molding machine includes
an injection unit including an input port of which a position with respect to the output port is fixed, and injecting the molten resin input to the input port into a mold,
a mold clamping unit that supports the mold to perform mold clamping of the mold,
a stand installed on a floor surface to support the injection unit and the mold clamping unit, and
a plurality of movement enabling units that enable the stand to move in a protrusion direction of an injection portion of the injection unit, independently of the injection unit and the floor surface.

19. A molten resin supply system comprising:
an output unit including an output port for outputting a molten resin, and in which a position of the output port is fixed; and
an injection molding machine that molds a molding product by using the output molten resin,
wherein the injection molding machine includes
an injection unit including an input port of which a position with respect to the output port is fixed, and injecting the molten resin input to the input port into a mold,
a mold clamping unit that supports the mold to perform mold clamping of the mold,
a stand that supports the injection unit and the mold clamping unit, and
a movement enabling unit that enables the mold clamping unit to move in a protrusion direction of an injection portion of the injection unit, independently of the injection unit and the stand.
